(19) United States
(12) Patent Application Publication
(10) Pub. No.: US 2025/0316924 A1
(43) Pub. Date: Oct. 9, 2025

(54) HIGH-DENSITY SOCKET CONNECTORS

(71) Applicant: Intel Corporation, Santa Clara, CA (US)

(72) Inventors: Lianchang Du, KUNSHAN (CN); Jeffory Smalley, East Olympia, WA (US); Srikant Nekkanty, Chandler, AZ (US); Xinjun Zhang, SHANGHAI (CN); Yi Zeng, Shanghai (CN); Zhichao Zhang, Chandler, AZ (US); Maoxin Yin, Shanghai (CN)

(73) Assignee: Intel Corporation, Santa Clara, CA (US)

(21) Appl. No.: 18/881,658

(22) PCT Filed: Sep. 26, 2022
(86) PCT No.: PCT/CN2022/121431

§ 371 Date: Jan. 6, 2025

(51) Int. Cl. H01R 13/508; H01R 12/71; H01R 13/10

(52) U.S. Cl. CPC H01R 13/508; H01R 12/716; H01R 13/10

(57) ABSTRACT

High-density socket connectors are disclosed herein. An example socket connector includes a first housing to be coupled to a substrate, The first housing has a first side, a second side opposite the first side, and a first opening extending through the first housing between the first side and the second side. The socket connector includes a socket pin disposed in the first opening. The socket connector further includes a second housing moveably coupled to the first housing. The second housing has a third side, a fourth side opposite the third side, and a second opening extending through the second housing between the third side and the fourth side. The socket pin extends into the second opening of the second housing. The second housing is moveable relative to the first housing between a first position and a second position.

### FIELD OF THE DISCLOSURE

This disclosure relates generally to socket connectors and, more particularly, to high-density socket connectors.

### BACKGROUND

The demand for greater computing power and faster computing times continues to grow. This has led to higher-density connectors on computer hardware components to transfer signals more quickly.

### BRIEF DESCRIPTION OF THE DRAWINGS

FIG. 1A is a bottom perspective view of an example cable connector having an example socket connector constructed in accordance with teachings of this disclosure.

FIG. 1B is a top perspective view of the example cable connector of FIG. 1A.

FIG. 2 is a perspective view of the example socket connector of FIG. 1A.

FIG. 3 is an exploded view of the example socket connector of FIG. 2.

FIG. 4 is a bottom side perspective view of a first example housing of the example socket connector of FIG. 2.

FIG. 5 is a bottom side perspective view of a second example housing of the example socket connector of FIG. 2.

FIG. 6 is a cross-sectional view of the example socket connector taken along line A-A of FIG. 2.

FIG. 7 is a cross-sectional view of the example socket connector taken along line B-B of FIG. 2.

FIG. 8 is an enlarged view of a portion of the second example housing of the example socket connector of FIG. 2.

FIG. 9 is a cross-sectional view of the example socket connector of FIG. 2 showing example socket pins.

FIG. 10 is a cross-sectional view of the example socket connector of FIG. 2 on an example substrate of the example cable connector of FIGS. 1A and 1B.

FIG. 11 is a cross-sectional view of an example substrate having an example mating connector for the example cable connector of FIGS. 1A and 1B.

FIG. 12 shows the example cable connector of FIGS. 1A and 1B connected to the example mating connector of FIG. 11.

FIG. 13 is a cross-sectional view of the example cable connector and the example mating connector of FIG. 12.

FIG. 14 is an enlarged view of the callout in FIG. 13.

FIG. 15 shows example pins of the example socket connector of FIG. 2 in an uncompressed state.

FIG. 16 shows the example pins of the example socket connector of FIG. 2 in a compressed state.

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used in this patent, stating that any part (e.g., a layer, film, area, region, or second housing) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” or “engaged” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

### DETAILED DESCRIPTION

As the computing industry evolves, the demand for higher input/output (IO) speeds and throughput continues to increase. Computer hardware components, such as central processing units (CPUs), graphical processing units (GPUs), memory, motherboards, etc. are often connected by electrical connectors. For example, a CPU in a server system may be connected to one or more other components by a cable connector that connects to a mating connector on a substrate or board of the CPU. A recent trend has been to increase the IO capability by adding more pin counts to the connectors on the CPUs. However, traditional cable connectors use two rows of pins, which is very low density. As a result, adding more pins to the cable connector requires more space on the board and therefore increases the overall size of the package. In some instances, there may not be enough space to add more pins. Manufacturers desire to keep the package size small while still increasing the IO capabilities.

Some example cable connectors use socket connector type connections. Socket connectors have an array or grid of socket pins. The socket pins are relatively thin and can be placed in a high-density arrangement, thereby improving the IO capability of a system. These socket pins are relatively fragile. Further, the socket pins are usually exposed and, thus, are prone to damage. Therefore, when a person is handling the socket connector, the person has to be cautious not to touch the socket pins or hit the socket pins on any foreign object, as this could easily bend or break the socket pins.

Disclosed herein are example socket connectors having a multi-layer housing that protects the socket pins when the socket connector is not connected to a mating connector. This reduces the chance of damage to the socket pins. As such, this enables users to adopt higher-density type connectors while reducing reliability and durability concerns.

Disclosed herein is an example socket connector. The socket connector can be part of a cable connector, or can be incorporated onto a board or substrate of a computing device (e.g., a CPU). The example socket connector includes a first housing. The first housing is to be coupled to the board or a substrate. The first housing has a plurality of openings (also referred to as sockets). The socket connector includes a plurality of socket pins disposed in respective ones of the openings. The socket pins engage contact pads on the substrate. The socket pins extend outward from a top side of the first housing. To protect the tips of the socket pins, the socket connector includes a second housing that is disposed on the top side of the first housing. The second housing has a corresponding plurality of openings. The socket pins extend outward from the first housing and into the openings of the second housing. As such, the second housing protects the tips of the socket pins. The second housing is moveably coupled to the first housing. In particular, the second housing is moveable toward or away from the first housing between a first position in which the second housing is a first distance from the first housing and a second position in which the second housing is a second distance from the first housing, which is less than the first distance. When the second housing is in the first position, the second housing substantially surrounds and protects the ends of the socket pins. In some examples, the socket connector has a spring to bias the second housing toward the first position. Therefore, when a person is handling the cable connector (e.g., while assembling the parts of a server), the second housing is in the first position and protects the tips/ends of the socket pins from damage. Then, when the socket connector is connected to a mating connector, the second housing is moved toward the first housing to the second position. This exposes the socket pins to enable the socket pins to be sufficiently engaged by corresponding pads or pins on the mating connector.

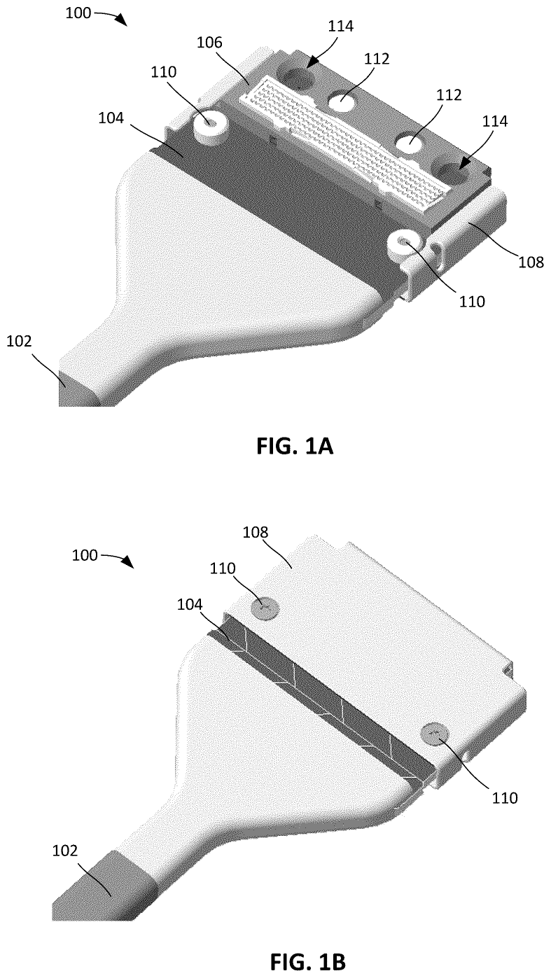

FIGS. 1A and 1B illustrate top and bottom sides of an example cable connector 100 on an end of an example cable 102. The cable connector 100 may also be referred to as a cable end or cable assembly. The cable 102 may contain one or more wires for routing signals and/or power. The cable connector 100 can be connected to a mating connector to connect the wires to another component. For example, the cable connector 100 can be connected to a mating connector on a board of a CPU. The cable connector 100 may be a high speed/high-density cable connector.

In the illustrated example of FIGS. 1A and 1B, the cable connector 100 includes a board or substrate 104, sometimes referred to as a paddle card. The substrate 104 may be a silicon substrate. The substrate 104 may include one or more metal contact pads and one or more traces that electrically connect the wires in the cable 102 to the contact pads, as shown in further detail herein.

In the illustrated example, the cable connector 100 includes an example socket connector 106. The example socket connector 106 includes a high-density array of socket pins (shown in further detail herein). When the socket connector 106 is connected to a mating connector, the socket pins engage other pins or contacts to provide an electrical connection. The socket connector 106 is coupled to the substrate 104. For example, in FIGS. 1A and 1B, the cable connector 100 includes a retainer 108 that couples (e.g., clamps) the socket connector 106 to the substrate 104. In the illustrated example, the retainer 108 is coupled to the substrate 104 via threaded fasteners 110 (e.g., screws, bolts, etc.). Additionally or alternatively, the example socket connector 106 can be coupled to the substrate 104 via fasteners 112 (e.g., threaded fasteners, rivets, etc.). Additionally or alternatively, the socket connector 106 and the substrate 104 can be coupled via heat staking. For example, a round-shaped extrusion can be formed on the socket connector 106, which extends into a corresponding opening on the substrate 104 for alignment. Then, the components are heated, which melts the extrusion to couple the socket connector 106 to the substrate 104. In other examples the socket connector 106 can be coupled to the substrate 104 via other manners (e.g., an adhesive).

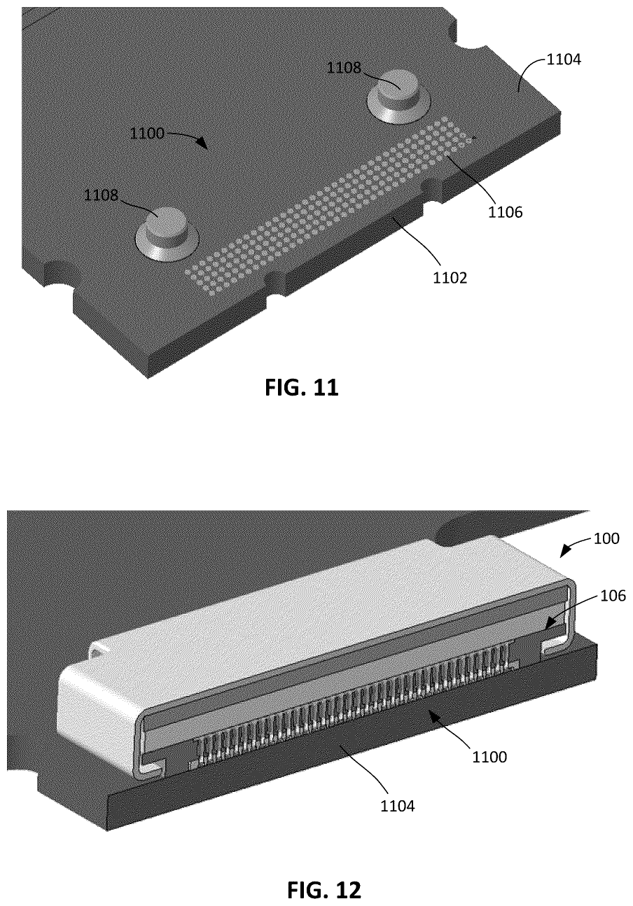

In the illustrated example, the socket connector 106 has mounting openings 114 (e.g., sockets) for receiving corresponding mounting pins on a mating connector, an example of which is shown in FIG. 11. The mounting openings 114 may also be referred to as surface-mount technology (SMT) sockets.

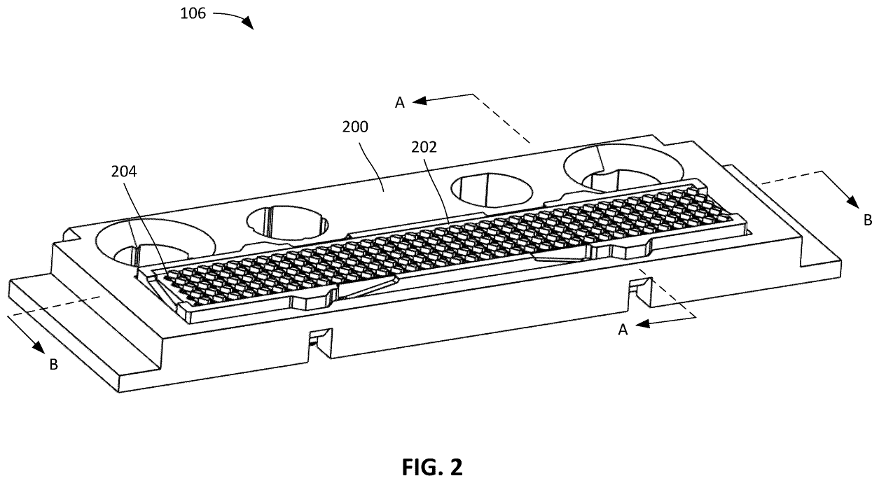

FIG. 2 is a perspective view of the example socket connector 106. In the illustrated example, the socket connector 106 includes a first housing 200 and second housing 202 coupled to the first housing 200. The first and second housings 200, 202 may also be referred to as first and second housing layers, respectively. In some examples, the first and second housings 200, 202 are constructed of plastic via injection molding. In other examples, the first and/or second housings 200, 202 can be constructed of other materials.

In the illustrated example, the socket connector 106 includes an array or plurality of socket pins 204 (one of which is referenced in FIG. 2). The socket pins 204 are constructed of conductive material, such as metal (e.g., copper, gold, silver, aluminum, etc.). In this example, the socket connector 106 includes 180 socket pins. However, the socket connector 106 can include any number of socket pins 204. In some examples, the socket connector 106 may include only one socket pin. In other examples, the socket connector 106 can include tens, hundreds, or even thousands of socket pins. The socket pins 204 are arranged in a tight or dense configuration to reduce (e.g., minimize) space consumption. In the illustrated example, the socket pins 204 extend upward or outward from the first housing 200. The second housing 202 is disposed on the first housing 200 and protects the ends of the socket pins 204 from damage. In this example, the second housing 202 is moveably coupled to the first housing 200. In particular, the second housing 202 is moveable toward or away from the first housing 200 (e.g., in a linear direction). The second housing 202 can move from a first position, shown in FIG. 2, in which the second housing 202 substantially covers the ends of the socket pins 204, to a second position, in which the second housing 202 is moved closer to the first housing 200 and a larger portion of each of the socket pins 204 is exposed. The first and second positions may also be referred to as upper and lower positions, respectively. As such, the second housing 202 helps protect the socket pins 204 when the socket connector 106 is being handled, but also allows the socket pins 204 to be accessible when connecting the socket connector 106 to a mating connector.

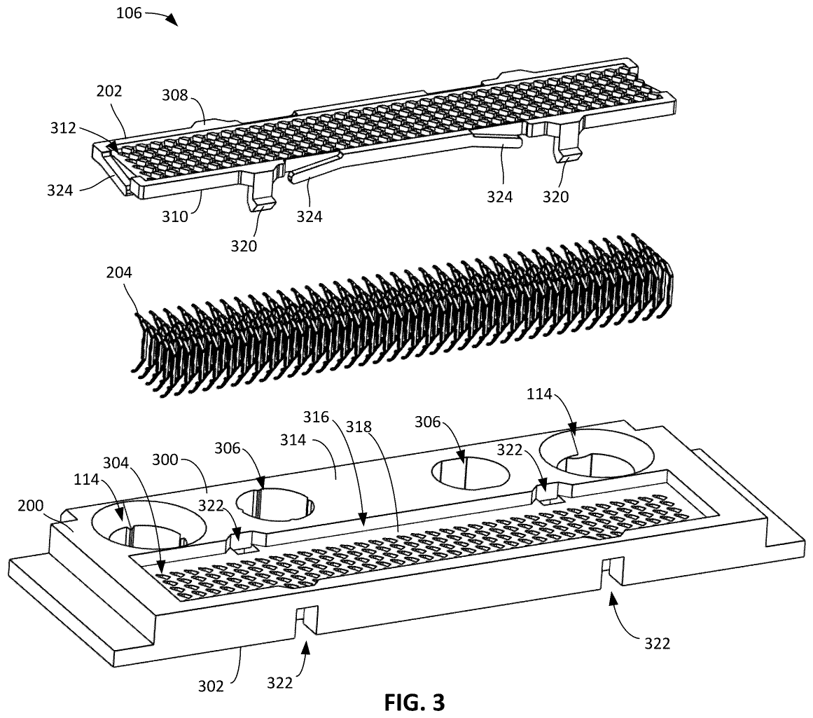

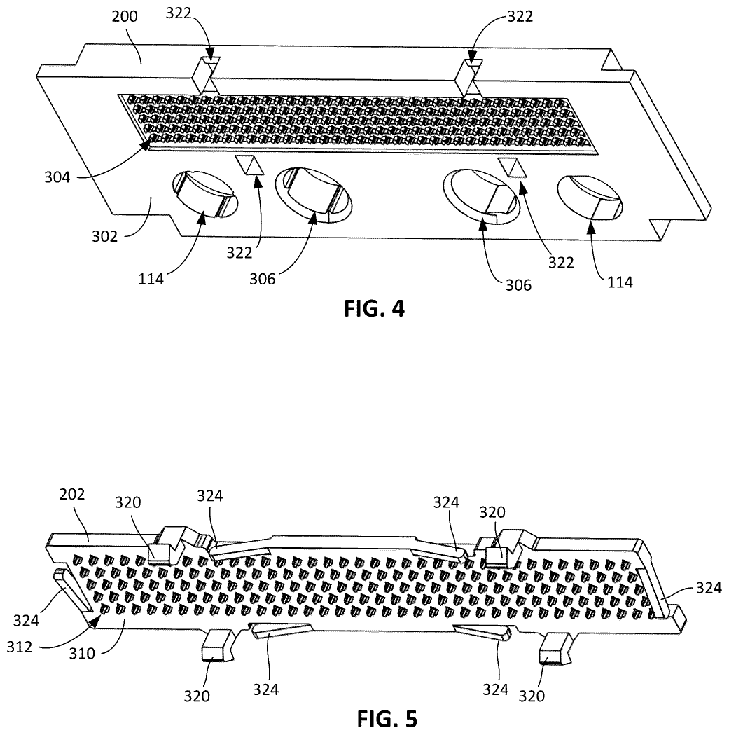

FIG. 3 is an exploded view of the example socket connector 106 showing the first housing 200, the second housing 202, and the socket pins 204 (one of which is referenced in FIG. 3). The first housing 200 has a first side 300 and a second side 302 opposite the first side 300. Referring briefly to FIG. 4, FIG. 4 is a perspective view of the second side 302 of the first housing 200. As shown in FIGS. 3 and 4, the first housing 200 has a plurality of openings 304 (one of which is referenced in each of FIGS. 3 and 4) extending through the first housing 200 between the first side 300 and the second side 302. The openings 304 may also be referred to as pin sockets. The first housing 200 may have any number of openings 304 (e.g., one, two, three, etc.) depending on the number of socket pins 206. When the socket connector 106 is assembled, the socket pins 204 are disposed in respective ones of the openings 304. The socket pins 204 extend outward or upward from the first side 300 of the first housing 200. In some examples, the socket pins 204 are moveable (e.g., slidable) in the openings 304. As shown in FIGS. 3 and 4, the first housing 200 includes the mounting openings 114. The first housing 200 also includes openings 306 for receiving the fasteners 112 (FIG. 1).

In the illustrated example of FIG. 3, the second housing 202 has a first side 308 and a second side 310 opposite the first side 308. Referring briefly to FIG. 5, FIG. 5 is a perspective view of the second side 310 of the second housing 202. When the socket connector 106 is assembled, the second housing 202 is disposed along the first side 300 of the first housing 200, such that the second side 310 of the second housing 202 is facing the first side 300 of the first housing 200. As shown in FIGS. 3 and 5, the second housing 202 has a plurality of openings 312 extending through the second housing 202 between the first side 308 and the second side 310. When the socket connector 106 is assembled, the openings 312 of the second housing 202 are aligned with the openings 304 of the first housing 200. Further, when the socket connector 106 is assembled, the socket pins 204 extend into respective ones of the openings 312 in the second housing 202 (from the second side 310).

In the illustrated example of FIG. 3, the first side 300 of the first housing 200 has a first surface 314, which forms an upper-or outer-most surface of the first housing 200. The first surface 314 has a recess 316 defining a second surface 318. As such, the second surface 318 is recessed relative to the first surface 314. The recess 316 is sized to receive the second housing 202. Therefore, when the socket connector 106 is assembled, the second housing 202 is at least partially disposed and/or moveable into the recess 316.

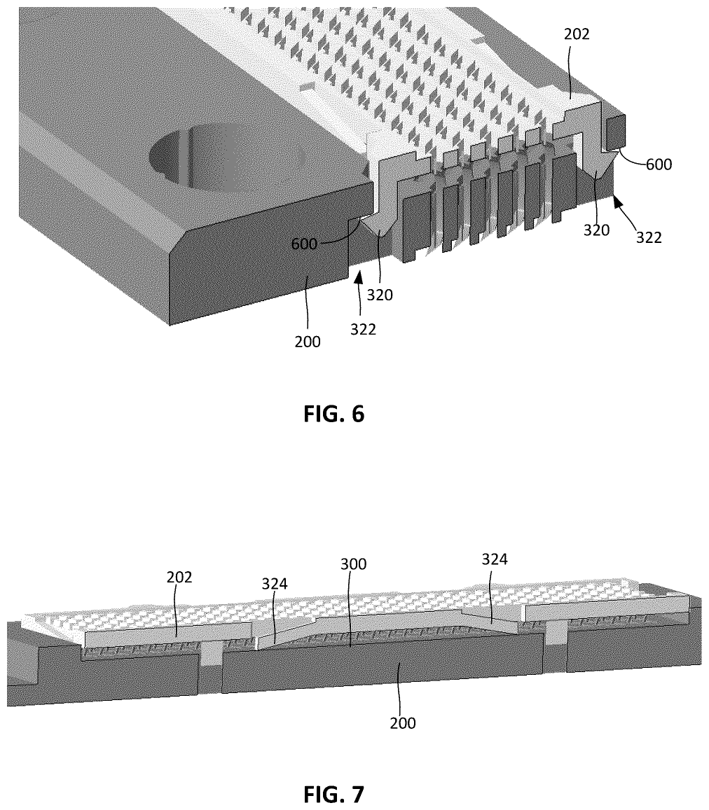

To moveably couple the second housing 202 to the first housing 200, the example socket connector 106 includes four hooks 320 (labeled in FIGS. 3 and 5). The hooks 320 may also be referred to as clips or retainers. In the illustrated example, the hooks 320 are coupled to and extend from the second side 310 of the second housing 202. In some examples, the hooks 320 are integrally formed with the second housing 202 (e.g., as a monolithic structure). As shown in FIGS. 3 and 4, the first housing 200 has four corresponding hook openings 322. When the socket connector 106 is assembled, the hooks 320 extend into respective ones of the hook openings 322. For example, FIG. 6 is a cross-sectional view taken along line A-A of FIG. 2 showing two of the hooks 320 in the hook openings 322. As shown in FIG. 6, the hooks 320 extend under shoulders 600 (in the orientation shown in FIG. 6) formed in the hook openings 322. As such, the second housing 202 can move (e.g., slide) up-and-down relative to the first housing 200, but when the hooks 320 engage the shoulders 600, the second housing 202 is limited or prevented from being moved further away from the first housing 200. This prevents the second housing 202 from inadvertently being removed from the first housing 200. This also defines the first or upper position of the second housing 202. However, the second housing 202 may be disconnected or removed from the first housing 200 by bending the hooks 320 inward to clear the shoulders 600. While in this example the socket connector 106 includes four hooks, in other examples the socket connector 106 can include more or fewer hooks (e.g., one hook, two hooks, three hooks, five hooks, six hooks, etc.). In other examples, the second housing 202 can be moveably coupled to the first housing 200 in other manners.

In some examples, the socket connector 106 includes one or more biasing members to bias the second housing 202 in a direction away from the first housing 200 and toward the first position. For example, referring to FIGS. 3 and 5, the socket connector 106 include six springs 324 to bias the second housing 202 toward the first position. In this example, the springs 324 are coupled to and extend from the second side 310 of the second housing 202. In some examples, the springs 324 are integrally formed with the second housing 202 (e.g., as a monolithic structure). In this example, the springs 324 are leaf springs, which are beams or members that are cantilevered from the second housing 202. These members are at least partially flexible. When the socket connector 106 is assembled, the springs 324 engage the first side 300 of the first housing 200 (particularly, the second surface 318). For example, FIG. 7 is a cross-sectional view taken along line B-B of FIG. 2 showing two of the springs 324 engaged with the first side 300 of the first housing 200. The springs 324 bias the second housing 202 away from the first housing 200 and toward the first position. When a force is applied to the second housing 202, such as when connecting the socket connector 106 to a mating connector, the springs 324 flex to enable the second housing 202 to be moved toward the first housing 200 to the second position. When the force is removed, the springs 324 expand to move the second housing 202 away from the first housing 200. While in this example the socket connector 106 includes six springs 324, in other examples the socket connector 106 can include more or fewer springs (e.g., one spring, two springs, three springs, etc.). Further, in other examples, other types of springs can be used (e.g., a metal elastic leaf spring, a coil spring) and/or the spring(s) can be coupled to and/or incorporated into the socket connector 106 in other manners. In other examples, other biasing members can be used, such as magnets and/or elastic sponges.

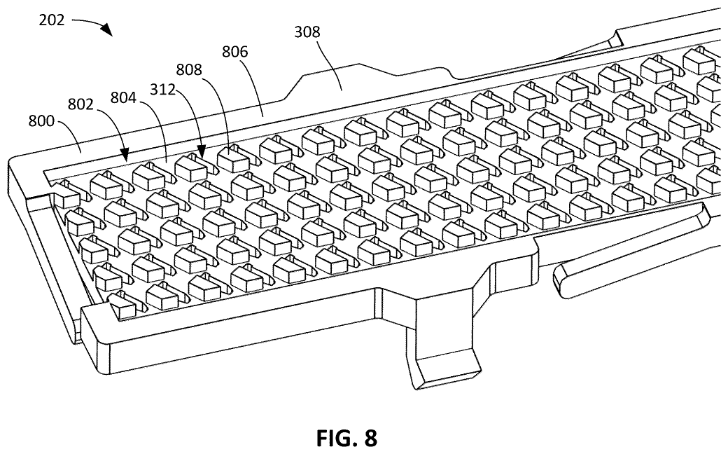

FIG. 8 is an enlarged view showing a portion of the first side 308 of the second housing 202. As shown in FIG. 8, the first side 308 of the second housing 202 has a first surface 800, which is the upper-or outer-most surface of the second housing 202. The first surface 800 has a recess 802, which defines a second surface 804 that is recessed relative to the first surface 800. The openings 312 (one of which is referenced in FIG. 8) extend through the second housing 202 between the second surface 804 and the second side 310.

In the illustrated example, the first surface 800 is at least partially formed by a rim 806 (e.g., a lip, an edge, etc.) that substantially surrounds the second surface 804. In the illustrated example, the second housing 202 also a plurality of extrusions 808 extending outward (e.g., upward) from the second surface 804. In the illustrated example, the extrusions 808 are arranged in a pattern and distributed between adjacent ones of the openings 312. The extrusions 808 form at least a portion of the first surface 800. The second housing 202 may include any number of extrusions 808 (e.g., one, two, three, etc.). The rim 806 and the extrusions 808 are spaced sufficiently close so that if the socket connector 106 engages an object, the object does not extend into the recess 802 (or extend very far into the recess 802) and damage the socket pins 204. Further, the extrusions 808 direct any pressure or force vertically, thereby preventing or limiting any side-to-side or swiping motion that could bend and damage the socket pins 204. For example, if a person's finger is pushed against the first surface 800, the rim 806 and/or the extrusions 808 prevent or limit the person's finger from swiping the socket pins 204 in a side-to-side movement. Any force against the socket pins 204 would only be in the vertical direction, which is acceptable because the socket pins 204 are configured to bend or compress in the vertical direction. However, the extrusions 808 do not interfere with the ability of the socket pins 204 to contact corresponding pads or pins of the mating connector.

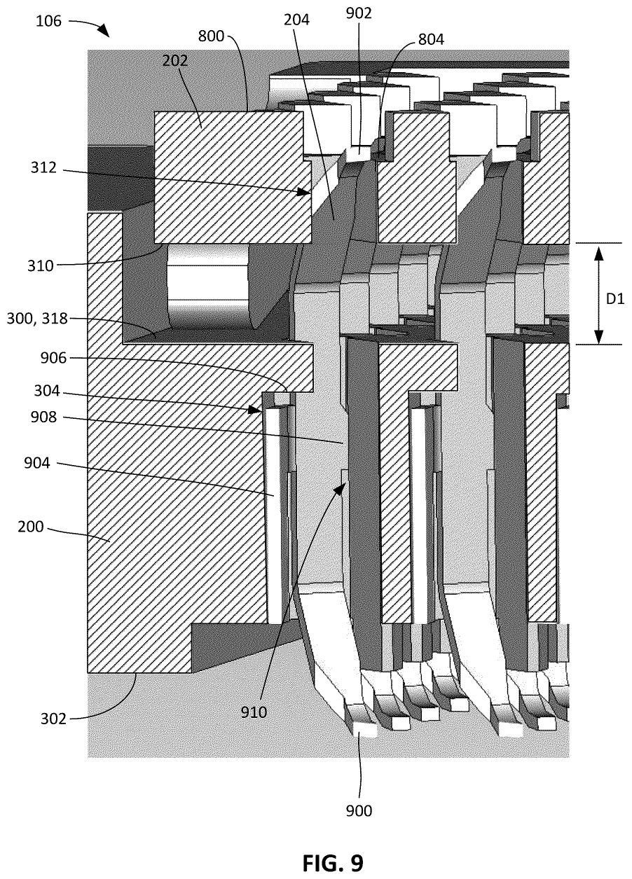

FIG. 9 is a cross-sectional view of the socket connector 106 showing the socket pins 204 (one of which is referenced in FIG. 9) in the first housing 200 and the second housing 202. One of the socket pins 204 is described in connection with FIG. 9. However, it is understood that the same description can apply to the other socket pins 204.

As shown in FIG. 9, the socket pin 204 is disposed in (and extends through) the opening 304 in the first housing 200. The socket pin 204 has a first end or tip 900 and a second end or tip 902 opposite the first tip 900. In this example, the first tip 900 extends outward from the second side 302 of the first housing 200. When the socket connector 106 is assembled on the substrate 104 (FIG. 1), the first tip 900 engages a contact pad on the substrate 104. In the illustrated example, the socket pin 204 extends upward from the second surface 318 of the first housing 200 and into the opening 312 in the second housing 202. In FIG. 9, the second housing 202 is in the first position. In this example, a portion of the socket pin 204 extends beyond the second surface 804 of the second housing 202 when the second housing 202 is in the first position. In particular, as shown in FIG. 9, the second tip 902 of the socket pin 204 is above the second surface 804. However, the second tip 902 of the socket pin 204 is still disposed below (in the orientation in FIG. 9) the first surface 800 of the second housing 202. Thus, the second tip 902 of the socket pin 204 is at least partially protected by the first surface 800 of the second housing 202. When the second housing 202 is moved to the second position, a larger portion of the socket pin 204 extends through the opening 312, which enables the socket pin 204 to make solid contact with a corresponding contact pad or pin on a mating connector, as shown in further detail herein. In other examples, the socket pin 204 may not extend beyond the second surface 804 when the second housing 202 is in the first position. Instead, the second tip 902 may be disposed in the opening 312 and below (in the orientation shown in FIG. 9) the second surface 804.

When the second housing 202 is in the first position, as shown in FIG. 9, the second side 310 of the second housing 202 is a first distance D1 from the first side 300 (at the second surface 318) of the first housing 200. When the second housing 202 is moved to the second position, the second side 310 of the second housing 202 is a second distance D2 (shown in FIG. 12) from the first side 300 (at the second surface 318) of the first housing 200, which is less than the first distance D1. In some examples, the second side 310 of the second housing 202 engages the first side 300 of the first housing 200 when the second housing 202 is in the second position. As such, the second distance D2 may be zero or substantially zero (e.g., within a tolerance of zero). In other examples, the socket connector 106 can be configured such that the second distance is greater than zero.

In this example, the socket pin 204 is slidable up-and-down in the opening 304 of the first housing 200. As shown in FIG. 9, the socket pin 204 has a curved profile (e.g., a C-shaped profile). When the socket connector 106 is connected to a mating connector, the socket pin 206 may compress (by bending) and/or slide in the opening 304. This enables the first tip 900 to make sufficient contact with a contact pad on the substrate 104 (FIG. 1) and the second tip 902 to made sufficient contact with a contact pad on the mating connector.

In the illustrated example, the socket pin 204 has an arm 904. The first housing 200 has a shoulder or overhang 906 above the arm 904. This prevents the socket pin 206 from being removed from the first side 300 of the first housing 200. Therefore, the first housing 200 holds the socket pins 204. Also, as shown in FIG. 9, the socket pin 206 has a tab 908 that extends into a slot 910 formed in the first housing 200. The tab 908 and the slot 910 ensure the socket pin 204 moves linearly up-and-down in the opening 304.

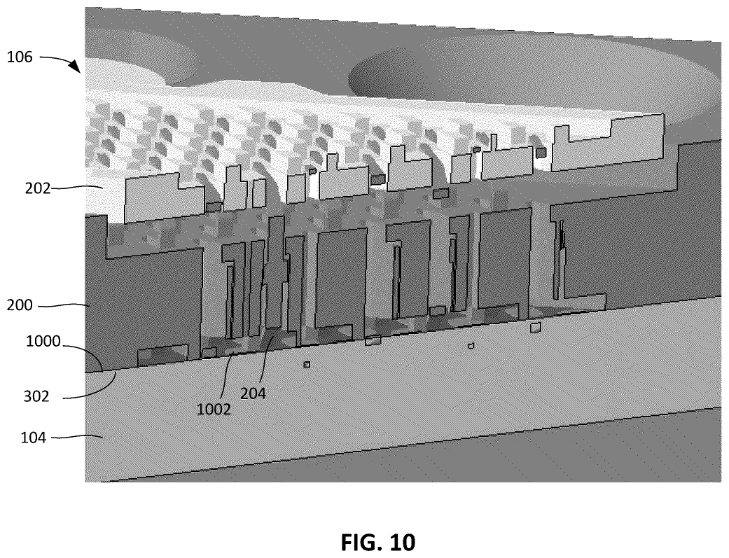

FIG. 10 is a cross-sectional view of the socket connector 106 on the substrate 104 of the cable connector 100 (FIG. 1). The socket connector 106 is disposed on a surface 1000 of the substrate 104. In particular, the second side 302 of the first housing 200 is disposed on (e.g., in contact with) the surface 1000 of the substrate 104. As disclosed above, the socket connector 106 can be coupled to the substrate 104 via the retainer 108 (FIG. 1) and/or the fasteners 112 (FIG. 1).

In the illustrated example, the substrate 104 has a plurality of contact pads 1002 (one of which is referenced in FIG. 10) on the surface 1000. The contact pads 1002 can be constructed of a conductive material (e.g., copper, gold, silver, aluminum, etc.). The substrate 104 may include traces or wires that connect one or more of the contact pads 1002 to the wire(s) in the cable 102 (FIG. 1). In some examples, the substrate 104 has the same number of contact pads 1002 as the number of socket pins 204 (one of which is referenced in FIG. 10). The contact pads 1002 are arranged in the same pattern and spacing as the socket pins 204 (e.g., a grid of 6×36). The socket pins 204 are engaged with respective ones of the contact pads 1002. As such, when the socket connector 106 is connected to a matching connector, the socket pins 206 provide electrical connection between the contact pads 1002 and the mating connector. In the example of FIG. 10, the second housing 202 is in the first position. As such, the second housing 202 substantially protects the socket pins 206 from damage.

FIG. 11 shows an example mating connector 1100 to which the example socket connector 106 (FIG. 1) can be connected. In this example, the mating connector 1100 is on a surface 1102 of a substrate 1104. The substrate 1104 may be, for example, a printed circuit board (PCB) of a central processing unit (CPU). In the illustrated example, the mating connector 1100 includes a plurality of contact pads 1106 (one of which is referenced in FIG. 11). The contact pads 1106 can be constructed of a conductive material (e.g., copper, gold, silver, aluminum, etc.). The contact pads 1106 are arranged in the same pattern as the socket pins 204. In the illustrated example, the mating connector 1100 includes two mounting pins 1108, which may be referred to as SMT pins. FIG. 12 is a cross-sectional view showing the cable connector 100 connected to the mating connector 1100 on the substrate 1104. When the cable connector 100 is pressed onto the mating connector 1100, the mounting pins 1108 (FIG. 11) are inserted into the mounting openings 114 (FIG. 1A) in the socket connector 106. In some examples, the mounting pins 1108 are friction fit in the openings 114. This provides a holding force to hold the socket connector 106 on the mating connector 1100. This holding force is greater than the force from the springs 324. As such, the socket connector 106 remains connected to the mounting pins 1108 until a sufficient force is provided (e.g., a force provided a person pulling the cable connector 100 off of the substrate 1104). This also aligns the socket connector 106 and the mating connector 1100.

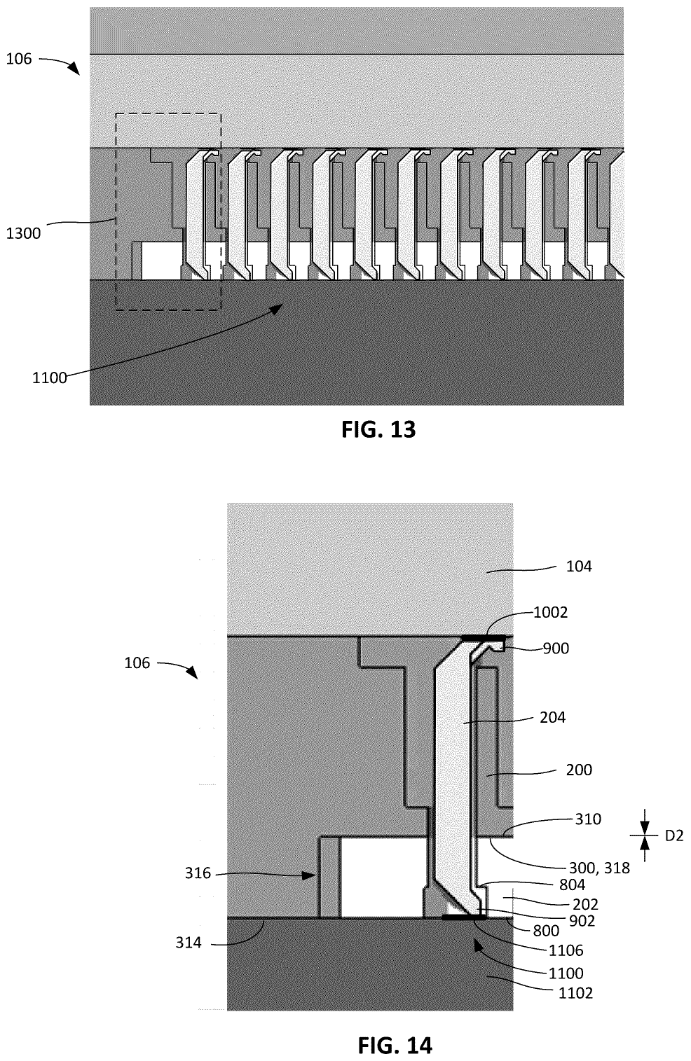

FIG. 13 is a side cross-sectional view of the socket connector 106 connected to the mating connector 1100. FIG. 14 is an enlarged view of the callout 1300 from FIG. 13, showing one of the socket pins 204. When the socket connector 106 is pushed onto the mating connector 1100, the second housing 202 is engaged by the substrate 1104 and pushed upward toward the first housing 200. In FIG. 14, the second housing 202 has been moved to the second position. In the second position, the second side 310 of the second housing 202 is the second distance D2 from the first side 300 (at the second surface 318) of the first housing 200. In this example, in the second position, the second housing 202 is engaged with the first side 300 of the first housing 200. Therefore, in this example, the second distance D2 is zero or substantially zero. However, in other examples, the second housing 202 can be spaced apart from the first side 300 of the first housing 200 when the second housing 202 is moved to the second position.

When the second housing 202 is moved from the first position to the second position, the second housing 202 moves into the recess 316 until the second side 310 of the second housing 202 contacts the second surface 318 of the first housing 200. In this example, the second housing 202 is about the same thickness as the depth of the recess 316. Therefore, when the second housing 202 is moved into the recess 316, the first surface 800 of the second housing 202 is aligned, substantially aligned (e.g., within a tolerance of being aligned), or flush with the first surface 314 of the first housing 200.

As described above, when the socket connector 106 is pressed onto the mating connector 1100, the second housing 202 engages the substate 1104 and is moved upward toward the first housing 200. This causes a larger portion of each of the socket pins 204 to be exposed from the second surface 804 of the second housing 202. Further, the contact pads 1106 on the substrate 1104 engages the second tip 902 of the socket pin 204. This pushes the first tip 900 of the socket pin 204 into the contact pad 1002. In some examples, the pressure causes the socket pins 206 to bend and/or compress. This pressure helps ensure the tips 900, 902 of the socket pin 204 maintain solid contact with the contact pads 1002, 1106 and overcome any contact resistance, thereby ensuring a suitable electrical path.

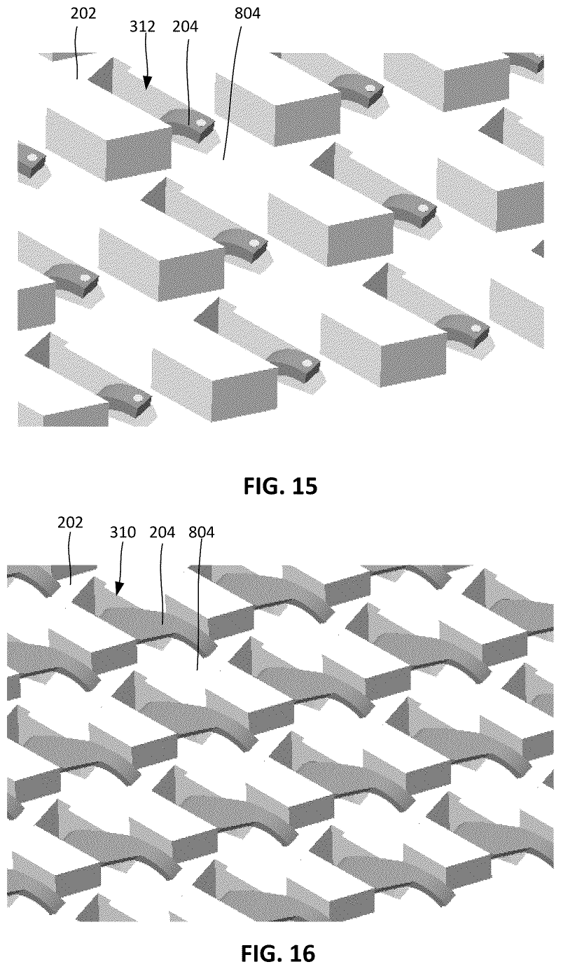

FIG. 15 shows the socket pins 204 (one of which is referenced in FIG. 15) extending from the openings 312 (one of which is referenced in FIG. 15) when the second housing 202 is in the first position and the socket pins 204 are not compressed. FIG. 16 shows the socket pins 204 (one of which is referenced in FIG. 16) extending from the openings 312 (one of which is referenced in FIG. 16) when the second housing 202 is moved to the second position and the socket pins 204 are compressed. As shown in FIG. 16, when the second housing 202 is moved to the second position, a larger portion of each of the socket pins 204 is exposed from or extending from the corresponding openings 312. Said another way, when the second housing 202 is in the first position (FIG. 15), a first portion or amount of each of the socket pins 204 extends from the second surface 804, and when the second housing 202 is in the second position (FIG. 16), a second portion or amount of each of the socket pins 204 extends from the second surface 804. The second portion or amount is greater than the first portion or amount.

In some examples, the socket connector 106 may include a third housing, similar to the second housing 202, disposed on the second side 302 of the first housing 200. The third housing can operate similar to the second housing 202 and protects the other ends of the socket pins 204. This may be beneficial for compress mount technology (CMT) systems that utilize pins on both sides of a connector.

While in the example disclosed above the first side 300 of the first housing 200 has the first surface 314 with the recess 316, in other examples, the first surface 314 may not have a recess. Instead, the first surface 314 may be substantially flat or planar. In such an example, the second housing 202 may move toward (and into contact with) and away from the first surface 314.

Also, while the example socket connector 106 is described in connection with a cable connector, the example socket connector 106 can be similarly used on any other hardware component. For example, the socket connector 106 can be used on a CPU substrate to connect one CPU to another CPU (e.g., a CPU disposed above or below the first CPU). The example socket connector 106 can be used for connecting any two components, such as a cable, a memory, a CPU, a rack, a server, a GPU, etc. In some examples, multiple ones of the socket connector 106 can be used on a component. For example, a rack of a server may have multiples one of the socket connector 106 and/or corresponding mating connectors. In some examples, the socket connector 106 and/or the mating connector can be used on an intermediary connector, used to connect two socket connectors and/or mating connectors.

While in some examples the socket pins 204 are moveable in the first housing 200, in other examples, the socket pins 204 may not be moveable in the first housing 200. In some examples, the socket pins 204 are fixed relative to the first housing 200. For example, for example, the socket pins 204 may be coupled (e.g., soldered) to the contact pads 1002 on the substrate 104. In such an example, the socket pins 204 may not be slidable in the first housing 200. Additionally or alternatively, the socket pins 204 can be coupled directly to the first housing 200.

While the terms top, bottom, over, under, above, and below are used herein to describe the relationship between certain components, it is understood that these terms are relative to the Earth or ground reference in a specific orientation. However, the example components disclosed herein can be disposed in any orientation. As such, in a first orientation, a first part may be described as being under a second part relative to the Earth reference, but in a second orientation, the first part may be over the second part relative to the Earth reference. Thus, these terms do not limit the components to a specific orientation. Also, while in some examples two or more components are described as being aligned or flush, it is understood that the components may not be perfectly aligned or flush. In some examples the components may not be parallel to each other and/or misaligned.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

From the foregoing, it will be appreciated that example systems, apparatus, and articles of manufacture have been disclosed that protect pins of socket type connectors. The examples disclosed herein reduce damage to socket pins, which enables the use of higher-density pin arrangements, which is desired for improved IO times.

Examples and combinations of examples disclosed herein include the following:

Example 1 is a socket connector comprising a first housing to be coupled to a substrate. The first housing has a first side, a second side opposite the first side, and a first opening extending through the first housing between the first side and the second side. The socket connector includes a socket pin disposed in the first opening and a second housing moveably coupled to the first housing. The second housing has a third side, a fourth side opposite the third side, and a second opening extending through the second housing between the third side and the fourth side. The fourth side of the second housing faces the first side of the first housing. The socket pin extends into the second opening of the second housing. The second housing is moveable relative to the first housing between a first position in which the third side of the second housing is a first distance from the first side of the first housing and a second position in which the third side of the second housing is a second distance from the first side of the first housing. The second distance is less than the first distance.

Example 2 includes the socket connector of Example 1, wherein the third side of the second housing has a first surface, and when the second housing is in the first position, a tip of the socket pin is disposed below the first surface.

Example 3 includes the socket connector of Example 2, wherein the third side of the second housing has a second surface that is recessed relative to the first surface, the second opening extending through the second housing between the second surface and the second side.

Example 4 includes the socket connector of Example 3, wherein the first surface is at least partially formed by a rim substantially surrounding the second surface.

Example 5 includes the socket connector of Example 4, wherein the first housing includes an extrusion extending from the second surface, the extrusion forming at least a portion of the first surface.

Example 6 includes the socket connector of any of Examples 3-5, wherein a portion of the socket pin extends from the second surface when the second housing is in the first position.

Example 7 includes the socket connector of any of Examples 1-6, wherein the fourth side of the second housing is engaged with the first side of the first housing when the second housing is in the second position.

Example 8 includes the socket connector of any of Examples 1-7, further including a spring to bias the second housing toward the first position.

Example 9 includes the socket connector of Example 8, wherein the spring is coupled to and extends from the fourth side of the second housing.

Example 10 includes the socket connector of Example 9, wherein the spring is engaged with the first side of the first housing.

Example 11 includes the socket connector of Example 10, wherein the spring is a leaf spring.

Example 12 includes the socket connector of any of Examples 1-11, further including a hook coupled to and extending from the fourth side of the second housing, the hook extending into a hook opening in the first housing.

Example 13 includes the socket connector of any of Examples 1-12, wherein the first side of the first housing has a first surface with a recess, and wherein the second housing is moveable into the recess when moved to the second position.

Example 14 includes the socket connector of any of Examples 1-13, wherein the socket pin is slidable in the first opening of the first housing.

Example 15 is a cable connector comprising a substrate having

a plurality of contact pads and a socket connector coupled to the substrate. The socket connector includes a first housing on the substrate, the first housing having a plurality of first openings, a plurality of socket pins disposed in respective ones of the first openings, the socket pins engaged with respective ones of the contact pads, and a second housing moveably coupled to the first housing, the second housing having a plurality of second openings, the socket pins extending into respective ones of the second openings.

Example 16 includes the cable connector of Example 15, wherein the socket connector includes a spring to bias the second housing in a direction away from the first housing.

Example 17 includes the cable connector of Examples 15 or 16, wherein second housing is moveable between a first position in which the second housing is spaced from the first side of the first housing and a second position in which the second housing is engaged with the first side of the first housing.

Example 18 includes a socket connector comprising a first housing to be coupled to a substrate. The first housing has a first side and a second side opposite the first side. The socket connector includes a socket pin extending from the first side of the first housing and a second housing moveably coupled to the first housing. The second housing has a third side and a fourth side opposite the third side. The fourth side of the second housing faces the first side of the first housing. The third side of the first housing has a first surface and a second surface recessed relative to the first surface. The second housing has an opening extending through the second housing between the second surface and the fourth side. The socket pin extends into the opening from the fourth side of the second housing. A tip of the socket pin is disposed below the first surface of the second housing.

Example 19 includes the socket connector of Example 18, wherein the second housing is moveable relative to the first housing between a first position in which a first portion of the socket pin extends from the second surface and a second position in which a second portion of the socket pin extends from the second surface, the second portion being greater than the first portion.

Example 20 includes the socket connector of Example 19, further including a spring to bias the second housing toward the first position.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. A socket connector comprising:
a first housing to be coupled to a substrate, the first housing having a first side, a second side opposite the first side, and a first opening extending through the first housing between the first side and the second side;
a socket pin disposed in the first opening; and
a second housing moveably coupled to the first housing, the second housing having a third side, a fourth side opposite the third side, and a second opening extending through the second housing between the third side and the fourth side, the fourth side of the second housing facing the first side of the first housing, the socket pin extending into the second opening of the second housing, the second housing is moveable relative to the first housing between a first position in which the third side of the second housing is a first distance from the first side of the first housing and a second position in which the third side of the second housing is a second distance from the first side of the first housing, the second distance being less than the first distance.

2. The socket connector of claim 1, wherein the third side of the second housing has a first surface, and when the second housing is in the first position, a tip of the socket pin is disposed below the first surface.

3. The socket connector of claim 2, wherein the third side of the second housing has a second surface that is recessed relative to the first surface, the second opening extending through the second housing between the second surface and the second side.

4. The socket connector of claim 3, wherein the first surface is at least partially formed by a rim substantially surrounding the second surface.

5. The socket connector of claim 4, wherein the first housing includes an extrusion extending from the second surface, the extrusion forming at least a portion of the first surface.

6. The socket connector of claim 3, wherein a portion of the socket pin extends from the second surface when the second housing is in the first position.

7. The socket connector of claim 1, wherein the fourth side of the second housing is engaged with the first side of the first housing when the second housing is in the second position.

8. The socket connector of claim 1, further including a spring to bias the second housing toward the first position.

9. The socket connector of claim 8, wherein the spring is coupled to and extends from the fourth side of the second housing.

10. The socket connector of claim 9, wherein the spring is engaged with the first side of the first housing.

11. The socket connector of claim 10, wherein the spring is a leaf spring.

12. The socket connector of claim 1, further including a hook coupled to and extending from the fourth side of the second housing, the hook extending into a hook opening in the first housing.

13. The socket connector of claim 1, wherein the first side of the first housing has a first surface with a recess, and wherein the second housing is moveable into the recess when moved to the second position.

14. The socket connector of claim 1, wherein the socket pin is slidable in the first opening of the first housing.

15. A cable connector comprising:
a substrate having a plurality of contact pads; and
a socket connector coupled to the substrate, the socket connector including:
a first housing on the substrate, the first housing having a plurality of first openings;
a plurality of socket pins disposed in respective ones of the first openings, the socket pins engaged with respective ones of the contact pads; and
a second housing moveably coupled to the first housing, the second housing having a plurality of second openings, the socket pins extending into respective ones of the second openings.

16. The cable connector of claim 15, wherein the socket connector includes a spring to bias the second housing in a direction away from the first housing.

17. The cable connector of claim 15, wherein second housing is moveable between a first position in which the second housing is spaced from the first side of the first housing and a second position in which the second housing is engaged with the first side of the first housing.

18. A socket connector comprising:
a first housing to be coupled to a substrate, the first housing having a first side and a second side opposite the first side;
a socket pin extending from the first side of the first housing; and
a second housing moveably coupled to the first housing, the second housing having a third side and a fourth side opposite the third side, the fourth side of the second housing facing the first side of the first housing, the third side of the first housing having a first surface and a second surface recessed relative to the first surface, the second housing having an opening extending through the second housing between the second surface and the fourth side, the socket pin extending into the opening from the fourth side of the second housing, a tip of the socket pin disposed below the first surface of the second housing.

19. The socket connector of claim 18, wherein the second housing is moveable relative to the first housing between a first position in which a first portion of the socket pin extends from the second surface and a second position in which a second portion of the socket pin extends from the second surface, the second portion being greater than the first portion.

20. The socket connector of claim 19, further including a spring to bias the second housing toward the first position.
